(19) United States
(12) Patent Application Publication
(10) Pub. No.: US 2006/0131173 A1
(43) Pub. Date: Jun. 22, 2006

(54) Method of coating an electric wire and insulated wire

(75) Inventors: Toshitaka Kawanami, Neyagawa-shi (JP); Hiroyuki Sakamoto, Neyagawa-shi (JP); Hidenori Tanaka, Neyagawa-shi (JP); Kazuo Morichika, Neyagawa-shi (JP); Takao Saito, Neyagawa-shi (JP)

Correspondence Address: CONNOLLY BOVE LODGE & HUTZ LLP, SUITE 800, 1990 M STREET NW, WASHINGTON, DC, 20036-3425, US

(73) Assignee: Nippon Paint Co., Ltd., Osaka-shi (JP)

(21) Appl. No.: 10/527,401

(22) PCT Filed: Sep. 12, 2003
(86) PCT No.: PCT/JP03/11683

§ 371 Date: Dec. 19, 2005

(30) Foreign Application Priority Data
Sep. 13, 2002 (JP) 2002-269018

(51) Int. Cl. C09D 5/44

(52) U.S. Cl. 204/502; 204/501

(57) ABSTRACT

In view of the above-discussed state of the art, it is an object of the present invention to provide a method of coating an electric wire by which insulated wires excellent in dielectric breakdown voltage can be obtained by a relatively short period of dipping of articles to be coated in an electrodeposition bath. A method of coating an electric wire comprising cationic electrocoating with a cationic electrodeposition coating composition, wherein the cationic electrodeposition coating composition contains a resin composition having a hydratable functional group reducible directly by an electron and results in forming passive coat.

### TECHNICAL FIELD

The present invention-relates to a method of coating an electric wire and an insulated wire.

### BACKGROUND ART

It has been a widespread practice to coat or cover electric wires by electrocoating using an anionic or cationic electrodeposition coating composition. Electric wires having an insulating coat or covering are being produced by this technique.

However, the conventional anionic or cationic electrocoating requires a relatively long period of time for the deposition of insulating coat in the process of electrocoating, hence it is necessary to secure a long time for dipping or immersing articles to be coated in an electrodeposition bath. Therefore, it is difficult to increase the line speed of electrocoating apparatus for the improvement of the production efficiency and reduce the cost.

While these electric wires obtained by the conventional method of electrocoating are generally in wide use, they are desired to be more improved in dielectric breakdown voltage so that may adequately be applied in a wider range of application fields. Therefore, the advent of a method of coating has been desired by which insulated wires excellent in dielectric breakdown voltage can be obtained even by electrocoating involving a relatively short period of time for dipping.

### SUMMARY OF THE INVENTION

In view of the above-discussed state of the art, it is an object of the present invention to provide a method of coating an electric wire by which insulated wires excellent in dielectric breakdown voltage can be-obtained by a relatively short period of dipping of articles to be coated in an electrodeposition bath.

The present invention-relates to a method of coating an electric wire comprising cationic electrocoating with a cationic electrodeposition coating composition,

wherein the cationic electrodeposition coating composition contains a resin composition having a hydratable functional group reducible directly by an electron and results in forming passive coat.

The above resin composition is preferably a sulfonium group- and propargyl group-containing one.

The above resin composition preferably has a sulfonium group content of 5 to 400 millimoles, a propargyl group content of 10 to 495 millimoles and a total content of the sulfonium and propargyl groups of not more than 500 millimoles, per 100 g of the solid matter in the resin composition.

The above resin composition preferably has a sulfonium group content of 5 to 250 millimoles, a propargyl group content of 20 to 395 millimoles and a total content of the sulfonium and propargyl groups of not more than 400 millimoles, per 100 g of the solid matter in the resin composition.

The above resin composition preferably has an epoxy resin as a skeleton.

The above epoxy resin is preferably a novolak cresol epoxy resin or a novolak phenol epoxy resin and preferably has a number average molecular weight of 700 to 5000.

The above cationic electrocoating is preferably carried out using a cationic electrocoating apparatus for an electric wire comprising an electrodeposition means, a washing means and a heating means as combined in that order.

The electrodeposition means is preferably one in which an article to be coated is immersed in an electrodeposition bath for 0.1 to 10 seconds.

The article to be coated is preferably an electric wire having at least one edge.

The article to be coated is preferably an square electric wire.

The present invention also relates to an insulated wire obtained by the above method of coating an electric wire.

### BRIEF DESCRIPTION OF THE DRAWING

FIG. 1 shows a schematic sectional view of a cationic electrocoating apparatus for an electric wire taken as an example.

### EXPLANATION OF THE NUMERICAL SYMBOLS

1 electrodeposition means
2 washing means
3 heating means
4 pretreatment means
5 electrodeposition bath
6 electrodeposition bath liquid
7 electric wire
8 washing bath
9 heating oven
10 degreasing bath
11 water washing bath
12 anode

### DETAILED DESCRIPTION OF THE INVENTION

In the following, the present invention is described in detail.

The method of coating an electric wire according to the invention is the method of coating an electric wire comprising cationic electrocoating with a cationic electrodeposition coating composition, wherein the cationic electrodeposition coating composition contains a resin composition having a hydratable functional group reducible directly by an electron and results in forming passive coat.

The mechanism of deposition on the cathode as caused by voltage application in the above-mentioned cationic electrocoating step is the one represented by the formula (I) shown below. When an electron is supplied to the a hydratable functional group which the resin composition (substrate; represented by “S” in the formula) on the electrode have, the resin composition is passivated and deposited.

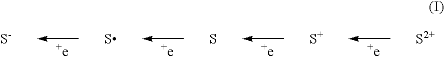

Thus, when the reaction shown by the above formula (I) occurs, the hydratable functional group occurring in the resin composition in the cationic electrodeposition coating composition are directly reduced, resulting in insolubilization and deposition of the resin composition. Therefore, when an article to be coated is immersed in the electrodeposition bath for a short period of time, a coat can be formed thereon.

On the contrary, when electrocoating is carried out using an anionic electrodeposition coating composition comprising a carboxyl group-containing resin, for instance, hydrogen ions are first formed on the anode in the electrocoating. Due to this hydrogen ion generation, the hydrogen ion concentration in the vicinity of the anode increases and, as a result, the carboxylic acid groups in the resin composition react with hydrogen ions, resulting in insolubilization and coat formation on the anode. In this case, a certain time is required for the hydrogen ion concentration in the vicinity of the anode to increase and, therefore, a prolonged period of time is required for coat deposition. Further, the coat once formed may be again ionized and dissolved in some instances and, in such cases, a further time is required for coat deposition. Further, when, for example, electrocoating is carried out using a cationic electrocoating composition comprising an amino group-containing resin, hydroxide ions are first formed on the cathode in the electrocoating. Due to this hydroxide ion generation, the hydroxide ion concentration in the vicinity of the cathode increases and, as a result, the amino groups in the resin are reacted with the hydroxide ions, resulting in insolubilization and coat formation on the cathode. In this case, too, a certain time is required for the hydroxide ion concentration in the vicinity of the cathode to increase and, therefore, the coat deposition time is also prolonged. Further, likewise, the coat once formed may be again ionized and dissolved and a further coat deposition time is required in some instances.

Thus, in cases where electrocoating is carried out using the electrodeposition coating compositions in conventional use, a certain coat deposition time is required in the electrocoating and, therefore, a certain time is also required for immersion in the electrodeposition bath. As a result, it is difficult to improve the production efficiency by increasing the line speed in the electrocoating apparatus to reduce the production cost of an insulated wire. On the contrary, the method of coating an electric wire according to the present invention makes it possible to form coat within a short immersion time and, thus, increase the line speed of the electrocoating apparatus in use, improve the productivity efficiency and reduce the production cost, since an electron is directly supplied to the hydratable functional group occurring in the resin composition in the cationic electrodeposition coating composition on the cathode and reduce the groups, and result in insolubilization and deposition of the resin composition.

In carrying out the method of coating an electric wire of the invention, the above resin composition is preferably a sulfonium group- and propargyl group-containing one. When cationic electrocoating is carried out using such resin composition, the line speed can be much increased and the production cost can be reduced accordingly, since the coat deposition rate is high as compared with the case of electrocoating with a cationic coating composition comprising an amino group-containing resin composition using the same electrocoating apparatus. Furthermore, an insulated wire obtained by using a cationic electrodeposition coating composition comprising a sulfonium group- and propargyl group-containing resin composition are superior in dielectric breakdown voltage.

The component resins of the above resin composition may have both a sulfonium group(s) and a propargyl group(s) in each molecule, but this is not absolutely necessary. Thus, for example, the component resins may have only a sulfonium group(s) or only a propargyl group(s) in each molecule. In the latter case, however, the whole resin composition should have both of these two kinds of curable functional groups. Thus, the resin composition may comprise any of sulfonium group- and propargyl group-containing resin, a mixture of a resin having only a sulfonium group(s) and a resin having only a propargyl group(s), and a mixture of all of said kinds of resins. It is herein defined in the above sense that the resin composition has both a sulfonium and a propargyl group(s).

The sulfonium group mentioned above is a hydratable functional group in the above resin composition. When an electric voltage or current exceeding a certain level is applied to the sulfonium group in the electrodeposition step, the group is electrically reduced on the electrode, whereby the ionic group disappears, resulting in irreversible passivation.

It is considered that, in this electrodeposition step, the electrode reaction provoked generates the hydroxide ion, which is held by the sulfonium ion, with the result that an electrolytically generated base is formed in the electrodeposited coat. This electrolytically generated base can convert the propargyl group occurring in the electrodeposited coat and being low in reactivity upon heating to the allene bond high in reactivity upon heating.

The resin to serve as the skeleton of the above resin composition is not particularly restricted but an epoxy resin is suitably used.

Suited for use as the epoxy resin are those having at least two epoxy group within each molecule, including, for example, such epoxy resins as epi-bis-epoxy resins, modifications thereof resulting from chain extension with a diol, dicarboxylic acid or diamine, for instance; epoxidized polybutadiene; novolak phenol polyepoxy resins; novolak cresol polyepoxy resins; polyglycidyl acrylate; polyglycidyl ethers of aliphatic polyols or polyethers polyol; and polyglycidyl esters of polybasic carboxylic acids. Among them, novolak phenol polyepoxy resins, novolak cresol polyepoxy resins and polyglycidyl acrylate are preferred because of the ease of polyfunctionalization for increasing curability. The above epoxy resin may partly comprise a monoepoxy resin.

The above resin composition preferably comprises any of the above-mentioned epoxy resin as a skeleton resins, with a number average molecular weight of 500 (lower limit) to 20,000 (upper limit). When the molecular weight is less than 500, the coating efficiency in the electrodeposition step will be poor and, when it exceeds 20,000, any good coat will be formed no longer on the substrate surface. The number average molecular weight can be selected within a more preferred range according to the resin skeleton. In the case of novolak phenol epoxy resins and novolak cresol epoxy resins, for instance, the lower limit is preferably 700 and the upper limit is preferably 5,000.

The sulfonium group content in the above resin composition should satisfy the condition concerning the total content of the sulfonium and propargyl groups, which is to be described later herein, and, in addition, the lower limit thereto is preferably set at 5 millimoles and the upper limit at 400 millimoles; per 100 g of the solid matter in the above resin composition. When it is lower than 5 millimoles/100 g, no satisfactory curability can be attained and deteriorations may result in hydratability and bath stability. When it exceeds 400 millimoles/100 g, the coat deposition on the substrate surface will become poor. The sulfonium group content can be selected within a more preferred range determined according to the resin skeleton employed. In the case of novolak phenol epoxy resins and novolak cresol epoxy resins, for instance, the above-mentioned lower limit is more preferably 5 millimoles, still more preferably 10 millimoles, and the upper limit is more preferably 250 millimoles, still more preferably 150 millimoles, per 100 g of the solid matter in the resin composition.

The propargyl group in the above resin composition serves as a curable functional group in the cationic electrodeposition coating composition.

The propargyl group content in the above resin composition should satisfy the condition concerning the total content of the sulfonium and propargyl groups, which is to be described later herein, and, in addition, the lower limit thereto is preferably set at 10 millimoles and the upper limit at 495 millimoles, per 100 g of the solid matter in the above resin composition. When it is lower than 10 millimoles/100 g, no satisfactory curability can be attained and, when it exceeds 495 millimoles/100 g, the hydration stability of the resin composition used in an electrodeposition coating composition may be adversely affected. The propargyl group content can be selected within a more preferred range according to the resin skeleton employed. In the case of novolak phenol epoxy resins and novolak cresol epoxy resins, for instance, the above-mentioned lower limit is more preferably 20 millimoles, and the upper limit is more preferably 395 millimoles, per 100 g of the solid matter in the resin composition.

The total content of the sulfonium and propargyl groups in the above resin composition is preferably not higher than 500 millimoles per 100 g of the solid matter in the resin composition. If it exceeds 500 millimoles/100 g, no resin may be actually obtained or no desired performance characteristics may be obtained. The total content of the sulfonium and propargyl groups in the above resin composition can be selected within a more preferred range according to the resin skeleton employed. In the case of novolak phenol epoxy resins and novolak cresol epoxy resins, for instance, the total content is more preferably not higher than 400 millimoles.

The propargyl group in the above resin composition may be partly converted to an acetylide. The acetylide is an acetylene bond-containing metal compound resembling a salt. As for the content of the acetylide-form propargyl group in the above resin composition, the lower limit hereto is preferably 0.1 millimole and the upper limit 40 millimoles, per 100 g of the solid matter in the resin composition. At content levels below 0.1 millimole, the effect of conversion to acetylides will not be produced to a satisfactory extent and, at content levels exceeding 40 millimoles, the conversion to acetylides is difficult. This content can be selected in a more preferred range according to the metal species employed.

The metal contained in the above-mentioned acetylide-form propargyl group is not particularly restricted but may be any of those metals which exhibit a catalytic activity, for example copper, silver, barium and other transition metals. From the viewpoint of applicability to the environment, copper and silver are preferred and, in view of availability, copper is more preferred. When copper is used, the content of the acetylide-form propargyl group in the above resin composition is more preferably 0.1 to 20 millimoles per 100 g of the solid matter in the resin composition.

Conversion of part of the propargyl group in the above resin composition to an acetylide can result in introduction of a curing catalyst into the resin. By doing so, it becomes unnecessary to use an organic transition metal complex generally soluble or dispersible only scarcely in organic solvents and water. Even a transition metal can be readily introduced after conversion to an acetylide into the resin, so that even a scarcely soluble transition metal compound can be freely used in the coating composition. Further, the occurrence of an organic acid salt as an anion in the electrodeposition bath, which is encountered when a transition metal organic acid salt is used, can be avoided and, furthermore, the metal ion will not be removed upon ultrafiltration, hence the bath management and electrodeposition coating composition designing become easy.

Where desired, the above resin composition may contain a carbon-carbon double bond. The carbon-carbon double bond is highly reactive, so that the curability can be further improved.

The carbon-carbon double bond content should satisfy the condition concerning the total content of the propargyl group and carbon-carbon double bond, which is to be described later herein, and, in addition, the lower limit thereto is preferably 10 millimoles and the upper limit at 485 millimoles, per 100 g of the solid matter in the above resin composition. When it is lower than 10 millimoles/100 g, no satisfactory curability can be attained by the addition thereof and, when it exceeds 485 millimoles/100 g, the hydration stability of the resin composition used in an electrodeposition coating composition may be adversely affected. The carbon-carbon double bond content can be selected within a more preferred range according to the resin skeleton employed. In the case of novolak phenol epoxy resins and novolak cresol epoxy resins, for instance, the above-mentioned lower and upper limits are preferably 20 millimoles and 375 millimoles, respectively, per 100 g of the solid matter in the resin composition.

When the resin composition contains the above-mentioned carbon-carbon double bond, the total content of the propargyl group and carbon-carbon double bond is preferably within the range from 80 millimoles (lower limit) to 450 millimoles (upper limit) per 100 g of the solid matter in the resin composition. At content levels lower than 80 millimoles/100 g, the curability may be unsatisfactory and, at levels exceeding 450 millimoles/100 g, the sulfonium group content becomes decreased and the dielectric breakdown voltage may become insufficient. The above total content of the propargyl group and carbon-carbon double bond can be selected within a more preferred range according to the resin skeleton employed. In the case of novolak phenol epoxy resins and novolak cresol epoxy resins, for instance, the above mentioned lower and upper limits are more preferably 100 millimoles and 395 millimoles, respectively, per 100 g of the solid matter in the resin composition.

When the resin composition contains the above carbon-carbon double bond, the total content of the above sulfonium and propargyl groups and carbon-carbon double bond is preferably not higher than 500 millimoles per 100 g of the solid matter in the resin composition. When it exceeds 500 millimoles/100 g, no resin can be actually obtained or some or other desired performance characteristics may be no longer obtained. The above total content of the sulfonium and propargyl groups and carbon-carbon double bond can be selected within a more preferred range according to the resin skeleton employed. In the case of novolak phenol epoxy resins and novolak cresol epoxy resins, for instance, it is preferably not higher than 400 millimoles per 100 g of the solid matter in the resin composition.

The above resin composition can suitably be produced, for example, by the step (i) of reacting an epoxy resin having at least two epoxy groups in each molecule with a compound having a functional group capable of reacting with the epoxy group and, further, a propargyl group to give a propargyl group-containing epoxy resin composition and the step (ii) of reacting the residual epoxy groups in the propargyl group-containing epoxy resin composition obtained in step (i) with a sulfide/acid mixture for sulfonium group introduction.

The above-mentioned compound having a functional group capable of reacting with the epoxy group and, further, a propargyl group (hereinafter referred to as “compound (A)”) may be, for example, a compound having both a functional group capable of reacting with the epoxy group, such as a hydroxyl or carboxyl group, and a propargyl group. As specific examples, there may be mentioned propargyl alcohol and propargylic acid, among others. Among these, propargyl alcohol is preferred in view of its availability and good reactivity.

For providing the resin composition with a carbon-carbon double bond according to need, a compound having a functional group capable of reacting with the epoxy group and, further, a carbon-carbon double bond (hereinafter referred to as “compound (B)”) is used in combination with the above-mentioned compound (A). The compound (B) may be a compound having both a functional group capable of reacting with the epoxy group, such as a hydroxyl or carboxyl group, and a carbon-carbon double bond. Specifically, when the group reacting with the epoxy group is a hydroxyl group, there may be mentioned 2-hydroxyethyl acrylate, 2-hydroxyethyl methacrylate, hydroxypropyl acrylate, hydroxypropyl methacrylate, hydroxybutyl acrylate, hydroxybutyl methacrylate, allyl alcohol, methallyl alcohol, and the like. When the group reacting with the epoxy group is a carboxyl group, there may be mentioned, among others, acrylic acid, methacrylic acid, ethacrylic acid, crotonic acid, maleic acid, phthalic acid, itaconic acid; half esters such as maleic acid ethyl ester, fumaric acid ethyl ester, itaconic acid ethyl ester, succinic acid mono(meth)acryloyloxyethyl ester, and phthalic acid mono(meth)acryloyloxyethyl ester; oleic acid, linolic acid, ricinolic acid, and like synthetic unsaturated fatty acids; and linseed oil, soybean oil, and like nature-derived unsaturated fatty acids.

In the above step (i), the epoxy resin having at least two epoxy groups in each molecule is reacted with the above compound (A) to give a propargyl group-containing epoxy resin composition or with the above compound (A) and the above compound (B) as necessary to give a propargyl group- and carbon-carbon double bond-containing epoxy resin composition. In the latter case, in the step (i), the compound (A) and compound (B) may be mixed together in advance and then subjected to reaction, or the compound (A) and compound (B) may be separately subjected to reaction. That functional group reacting with the epoxy group which the compound (A) has and that functional group reacting with the epoxy group which the compound (B) has may be the same or different.

When, in the above step (i), the compound (A) and compound (B) are subjected to reaction with the epoxy resin, the proportion between both compounds may be selected so that a desired functional group content may be obtained, for example that the above-mentioned propargyl group and carbon-carbon double bond contents may be obtained.

As for the reaction conditions in the above step (i), the reaction is generally carried out at room temperature or 80 to 140° C. for several hours. If necessary, one or more known ingredients necessary for the progress of the reaction, such as a catalyst and/or solvent, may be used. The completion of the reaction can be checked by epoxy equivalent determination, and the functional group introduced can be confirmed by analysis of nonvolatile fraction and instrumental analysis of the resin composition obtained. The thus-obtained reaction product generally occurs as a mixture of epoxy resins having one or a plurality of propargyl groups, or a mixture of epoxy resins having one or a plurality of propargyl groups and carbon-carbon double bonds. In this sense, the resin composition obtained in the above step (i) is a propargyl group-containing one or a propargyl group- and carbon-carbon double bond-containing one.

In the step (ii), the residual groups in the propargyl group-containing epoxy resin composition obtained in the above step (i) are reacted with a sulfide/acid mixture for sulfonium group introduction. This introduction of the sulfonium group can be effected by the method which comprises causing the sulfide/acid mixture to react with the epoxy group to effect introduction of the sulfide and conversion thereof to the sulfonium group or the method which comprises introducing a sulfide and then converting the introduced sulfide to a sulfonium group with an acid, an alkyl halide, such as methyl fluoride, methyl chloride or methyl bromide, or the like reagent, if necessary, followed by anion exchange. In view of the availability of the reactant, the method using a sulfide/acid mixture is preferred.

The above sulfide is not particularly restricted but includes, among others, aliphatic sulfides, aliphatic-aromatic mixed sulfides, aralkyl sulfides, and cyclic sulfides. Specifically, there may be mentioned, for example, diethyl sulfide, dipropyl sulfide, dibutyl sulfide, dihexyl sulfide, diphenyl sulfide, ethyl phenyl sulfide, tetramethylene sulfide, pentamethylene sulfide, thiodiethanol, thiodipropanol, thiodibutanol, 1-(2-hydoxyethylthio)-2-propanol, 1-(2-hydroxyethylthio)-2-butanol, and 1-(2-hydroxyethylthio)-3-butoxy-1-propanol.

The above-mentioned acid is not particularly restricted but includes, among others, formic acid, acetic acid, lactic acid, propionic acid, boric acid, butyric acid, dimethylolpropionic acid, hydrochloric acid, sulfuric acid, phosphoric acid, N-acetylglycine, and N-acetyl-β-alanine.

The mixing ratio between the sulfide and acid in the above sulfide/acid mixture is generally and preferably about 100/40 to 100/100 as expressed in terms of sulfide/acid mole ratio.

The reaction in the above step (ii) can be carried out, for example, by mixing the propargyl group-containing epoxy resin composition obtained in the above step (i) and the above sulfide/acid mixture in an amount selected so as to give the above-mentioned sulfonium group content, for instance, with water in an amount of 5 to 10 moles per mole of the sulfide used and stirring the mixture generally at 50 to 90° C. for several hours. A residual acid value of 5 or below may serve as a criterion in judging the reaction to be at the end point. The sulfonium group introduction in the resin composition obtained can be confirmed by potentiometric titration.

The same procedure can be used also in the case where the sulfide is first introduced and then converted to the sulfonium group. By carrying out introduction of the sulfonium group after introduction of the propargyl group, as mentioned above, the sulfonium group can be prevented from being decomposed upon heating.

When the propargyl group in the above resin composition is partly converted to an acetylide, conversion to the acetylide can be carried out by the step of reacting the propargyl group-containing epoxy resin obtained in the above step (i) with a metal compound to thereby convert part of the propargyl group in the above-mentioned epoxy resin composition to the corresponding acetylide. The metal compound is preferably a transition metal compound capable of giving an acetylide and includes, among others, complexes or salts of such transition metals as copper, silver and barium. Specifically, there may be mentioned, for example, acetylacetonato-copper, copper acetate, acetylacetonato-silver, silver acetate, silver nitrate, acetylacetonato-barium, and barium acetate. Among these, copper or silver compounds are preferred from the environmental friendliness viewpoint, and copper compounds are more preferred because of their ready availability. For example, acetylacetonato-copper is suitably used in view of the ease of bath control.

As regards the reaction conditions for converting partly the propargyl group to an acetylide, the reaction is generally carried out at 40 to 70° C. for several hours. The progress of the reaction can be checked by the coloration of the resulting resin composition and/or the disappearance of the methine proton signal on a nuclear magnetic resonance spectrum. The time when the propargyl group-derived acetylide in the resin composition arrives at a desired level is thus determined and, at that time, the reaction is terminated. The reaction product obtained is generally a mixture of epoxy resins with one or a plurality of propargyl groups converted to an acetylide. A sulfonium group can be introduced, by the above step (ii), into the thus obtained epoxy resin composition with the propargyl group partly converted to an acetylide.

The step of partly converting the propargyl group in the epoxy resin composition to an acetylide and the step (ii) can be carried out under common reaction conditions, so that both steps can be carried out simultaneously. The production process can be advantageously simplified by carrying out both steps simultaneously.

In this way, the propargyl group- and sulfonium group-containing resin composition optionally containing a carbon-carbon double bond and/or a propargyl group-derived acetylide according to need can be produced while preventing the sulfonium group from being decomposed. Although acetylides in a dry state are explosive, the reaction in the practice of the invention is carried out in an aqueous medium and the desired substance can be obtained in the form of an aqueous composition. Therefore, there arises no safety problem.

Since the above-mentioned cationic electrodeposition coating composition comprises the above-mentioned resin composition and the resin composition itself is curable, it is not always necessary to use a curing agent. However, for further improving the curability, a curing agent may be used. As such curing agent, there may be mentioned, among others, compounds having a plurality of propargyl groups and/or carbon-carbon double bonds, for example compounds obtained by subjecting a propargyl group-containing compound, such as propargyl alcohol, or a carbon-carbon double bond-containing compound, such as acrylic acid, to addition reaction to a novolak phenol- or like compound-derived polyepoxide or pentaerythritol tetraglycidyl ether.

It is not always necessary to use a curing catalyst in the above cationic electrodeposition coating composition. However, when a further improvement in curability is required depending on the curing reaction conditions, a transition metal compound in general use, for instance, may be added in an appropriate amount according to need. Such compound is not particularly restricted but includes, among others, complexes or compounds resulting from combination with a ligand, such as cyclopentadiene or acetylacetone, or a carboxylic acid, such as acetic acid, to transition metals such as nickel, cobalt, manganese, palladium, and rhodium. The level of addition of the above curing catalyst is preferably from 0.1 millimole (lower limit) to 20 millimoles (upper limit) per 100 g of the resin solids in the cationic electrodeposition coating composition.

An amine may further be incorporated in the above cationic electrodeposition coating composition. By the addition of the amine, the conversion of the sulfonium group to a sulfide by electrolytic reduction in the process of electrodeposition is increased. The amine is not particularly restricted but includes, among others, amine compounds such as primary to tertiary monofunctional or polyfunctional aliphatic amines, alicyclic amines and aromatic amines. Among these, water-soluble or water-dispersible ones are preferred and, thus, mention may be made of C₂₋₈ alkylamines such as monomethylamine, dimethylamine, trimethylamine, triethylamine, propylamine, diisopropylamine and tributylamine; monoethanolamine, dimethanolamine, methylethanolamine, dimethylethanolamine, cyclohexylamine, morpholine, N-methylmorpholine, pyridine, pyrazine, piperidine, imidazoline, imidazole and the like. These may be used singly or two or more of them may be used in combination. Among them, hydroxy amines such as monoethanolamine, diethanolamine and dimethylethanolamine are preferred from the view point of excellent dispersion stability in water.

The above amine can be directly incorporated in the above cationic electrodeposition coating composition. While, in the conventional neutralized amine type electrodeposition coating compositions, the addition of a free amine results in deprivation of the neutralizing acid in the resin, hence in marked deterioration of the stability of the electrodeposition solution, no such bath stability trouble will arise in the practice of the present invention.

The level of addition of the above amine is preferably 0.3 milliequivalents (meq) (lower limit) to 25 meq (upper limit) per 100 g of the resin solid matter in the cationic electrodeposition coating composition. If it is less than 0.3 meq/100 g, the film thickness retention may become insufficient. If it exceeds 25 meq/100 g, the effects proportional to the addition level can no longer be obtained; this is not economical. The lower limit is more preferably 1 meq/100 g, and the upper limit is more preferably 15 meq/100 g.

In the above cationic electrodeposition coating composition, there may be incorporated an aliphatic hydrocarbon group-containing resin composition. The incorporation of the aliphatic hydrocarbon group-containing resin composition improves the impact resistance of the coating film. The aliphatic hydrocarbon group-containing resin composition includes those containing, per 100 g of the solid matter in the resin composition, 5 to 400 millimoles of a sulfonium group, 80 to 135 millimoles of a C₈₋₂₄ aliphatic hydrocarbon group, which may optionally contain an unsaturated double bond in the chain thereof, and 10-315 millimoles of at least one of an unsaturated double bond-terminated C₃₋₇ organic group and a propargyl group, with the total content of the sulfonium group, the C₈₋₂₄ aliphatic hydrocarbon group, which may optionally contain an unsaturated double bond in the chain thereof, the unsaturated double bond-terminated C₃₋₇ organic group and the propargyl group being not higher than 500 millimoles per 100 g of the-solid matter in the resin composition.

When such aliphatic hydrocarbon group-containing resin composition is incorporated in the above-mentioned cationic electrodeposition coating composition, each 100 g of the resin solid matter in the cationic electrodeposition coating composition preferably contains 5 to 400 millimoles of the sulfonium group, 10 to 300 millimoles of the C₈₋₂₄ aliphatic hydrocarbon group, which may optionally contain an unsaturated double bond in the chain thereof, and 10 to 485 millimoles of the propargyl group and unsaturated double bond-terminated C₃₋₇ organic group in total, the total content of the sulfonium group, the C₈₋₂₄ aliphatic hydrocarbon group, which may optionally contain an unsaturated double bond in the chain thereof, the propargyl group and the unsaturated double bond-terminated C₃₋₇ organic group is preferably not higher than 500 millimoles per 100 g of the resin solid matter in the cationic electrodeposition coating composition, and the content of the above C₈₋₂₄ aliphatic hydrocarbon group, which may optionally contain an unsaturated double bond in the chain thereof, is preferably 3 to 30% by mass based on the resin solid matter in the electrodeposition coating composition.

In cases where the aliphatic hydrocarbon group-containing resin composition is incorporated in the above cationic electrodeposition coating composition, when the sulfonium group content is below 5 millimoles/100 g, no sufficient curability can be exhibited and deteriorations in hydratability and bath stability will result. When it exceeds 400 millimoles/100 g, the coat deposition on the substrate surface becomes poor. When the content of the C₈₋₂₄ aliphatic hydrocarbon group, which may optionally contain an unsaturated double bond in the chain thereof, is less than 80 millimoles/100 g, the improvement in impact resistance will be unsatisfactory and, when it exceeds 350 millimoles/100 g, the resin composition becomes difficult to handle. When the total content of the propargyl group and the C₃₋₇ unsaturated double bond-terminated organic group is lower than 10 millimoles/100 g, no satisfactory curability will be produced even when another resin and/or a curing agent is used combinedly. When it exceeds 315 millimoles/100 g, the impact resistance will be improved only to an unsatisfactory extent. The total content of the sulfonium group, the C₈₋₂₄ aliphatic hydrocarbon group, which may optionally contain an unsaturated double bond in the chain thereof, the propargyl group and the C₃₋₇ unsaturated double bond-terminated organic group is not more than 500 millimoles per 100 g of the solid matter in the resin composition. When it exceeds 500 millimoles, no resin will be actually obtained or the desired performance characteristics may not be obtained.

The above cationic electrodeposition coating compositions may further contain, according to need, other ingredients generally used in the conventional cationic electrodeposition coating compositions. The other ingredients are not particularly restricted but include, among others, pigments, rust preventives, pigment dispersant resins, surfactants, antioxidants, and ultraviolet absorbers. When they are used, however, care should be taken so that the dielectric breakdown voltage level may be retained.

The above-mentioned pigments are not particularly restricted but include, among others, color pigments such as titanium dioxide, carbon black and red iron oxide; rust-preventive pigments such as basic lead silicate and aluminum phosphomolybdate; and extender pigments such as kaolin, clay and talc. The above-mentioned rust preventives specifically include calcium phosphite, zinc calcium phosphite, calcium-carrying silica, calcium-carrying zeolite, etc. The total addition level for such pigments and rust preventives is preferably 0% by mass (lower limit) to 50% by mass (upper limit) based on the solid matter in the cationic electrodeposition coating composition.

The above pigment dispersant resins are used to stably disperse the above pigments in the cationic electrodeposition coating composition. The pigment dispersant resins are not particularly restricted but include those pigment dispersant resins which are in general use. A pigment dispersant resin containing a sulfonium group and an unsaturated bond within the resin may also be used. Such sulfonium group- and unsaturated bond-containing pigment dispersant resin can be obtained, for example, by the method comprising reacting a sulfide compound with a hydrophobic epoxy resin obtained by reacting a bisphenol-based epoxy resin with a half-blocked isocyanate, or reacting the above resin with a sulfide compound in the presence of a monobasic acid and a hydroxyl group-containing dibasic acid. The above pigment dispersant resins can also stably disperse the above-mentioned heavy metal-free rust preventives in the cationic electrodeposition coating composition.

The above cationic electrodeposition coating composition can be prepared, for example, by admixing the above resin composition with the above-mentioned other ingredients according to need and dissolving or dispersing the resulting composition in water. On the occasion of use in the electrodeposition step, the bath solution/dispersion prepared preferably has a nonvolatile matter content of 5% by mass (lower limit) to 40% by mass (upper limit). The preparation is preferably carried out so that the contents of the propargyl group, carbon-carbon double bond and sulfonium group in the electrodeposition coating composition may not deviate from the respective ranges indicated hereinabove referring to the resin composition.

In the method of coating an electric wire of the invention, the above cationic electrocoating can be carried out using an electrocoating apparatus in which the conventional cationic cationic electrocoating can be carried out. For example, the above electrocoating can be carried out using a cationic electrocoating apparatus for electric wire which comprises an electrodeposition means, a washing means, and a heating means combined in that order. In this way, insulated wire excellent from the dielectric breakdown voltage viewpoint can be obtained in an efficient manner. The electrocoating apparatus that can be used may be a horizontal electrocoating apparatus in which electrocoating is carried out while an electric wire, which are articles to be coated, is pulled horizontally, or a vertical electrocoating apparatus in which an electric wire, which is articles to be coated, are introduced into the electrodeposition bath from the bottom thereof and pulled out from the top of the electrodeposition bath.

The above electrodeposition means is intended for carrying out the electrocoating using the cationic electrodeposition coating composition to form a coat on the surface of an electric wire, which are articles to be coated. The above electrodeposition means is not particularly restricted but may be any of those by which the intended cationic electrocoating can be carried out.

The above electrodeposition means is preferably one in which articles to be coated are immersed in the electrodeposition bath for 0.1 to 10 seconds. The method of coating an electric wire of the invention uses a cationic electrodeposition coating composition which contains a resin composition having a hydratable functional group reducible directly by an electron and results in forming passive coat, so that a coat excellent in dielectric breakdown voltage characteristics can be formed on the surface of an electric wire in a short period of immersion in the electrodeposition bath. Therefore, even in such a relatively short immersion time, an insulated wire excellent in performance characteristics can be obtained. When the immersion time is shorter than 0.1 second, the amount of the coat formed will be insufficient, possibly making the coat inferior in dielectric breakdown voltage. A longer time exceeding 10 seconds cannot be expected to produce any further marked improvement in dielectric breakdown voltage, hence is uneconomical.

In operating the above electrodeposition means, the method comprising, for example, immersing an electric wire in the above cationic electrodeposition coating composition for utilizing the wire as a cathode, and applying a voltage generally within the range of 50 to 450 V between the cathode and an anode may be mentioned as an example. When the voltage applied is lower than 50 V, the dielectric breakdown voltage may possibly lower and insufficient electrodeposition will result. At a voltage exceeding 450 V, the electricity consumption uneconomically increases. When the above cationic electrodeposition coating composition is used and a voltage within the above range is applied, a uniform coat can be formed on the whole material surface, without any rapid increase in film thickness in the process of electrodeposition. In ordinary cases, the cationic electrodeposition coating composition bath temperature when the above voltage is applied is preferably 10 to 45° C.

The above-mentioned washing means is intended for washing the electric wire with the cationic electrodeposition coating composition adhering thereto to remove the electrodeposition bath liquid. The washing means is not particularly restricted but may be any the conventional washing apparatus. For example, there may be mentioned an apparatus in which the electrodeposition-coated wire is washed using, as a washing liquid, the filtrate obtained by ultrafiltration of the electrodeposition bath liquid. As the above-mentioned heating means, there may be specifically mentioned a hot air drying oven, a near-infrared heating oven, a far-infrared heating oven, and an induction heating oven, for instance.

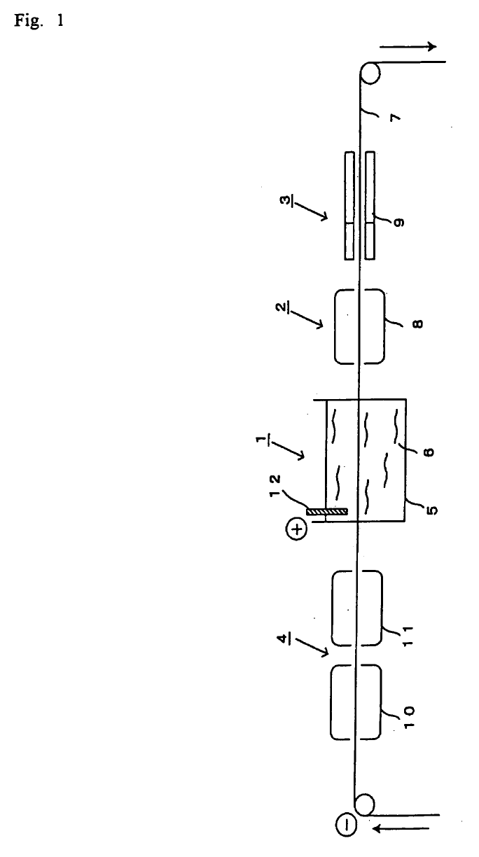

In the following, the cationic electrocoating apparatus for an electric wire which is to be used in the practice of the invention is described referring to the attached drawing. FIG. 1 is a schematic sectional view of a typical cationic electrocoating apparatus for an electric wire. This cationic electrocoating apparatus for an electric wire comprise an electrodeposition means 1, a washing means 2, and a heating means 3, as combined in that order. This cationic electrocoating apparatus for an electric wire can further comprise a pretreatment means 4.

The electrodeposition means 1, which is the key member of the cationic electrocoating apparatus for an electric wire in the practice of the invention, is equipped with an electrodeposition bath 5 and an anode 12, with an electrodeposition bath liquid 6 stored in the electrodeposition bath 5. The anode 12 is intended for carrying out cationic electrocoating utilizing an electric wire 7, which is an article to be coated, as a counter electrode. The constitution is such that electrocoating is carried out by immersing the wire 7 in the electrodeposition bath liquid 6 in the electrodeposition bath 5 for forming a coat on the wire and the wire 7 with the coat formed thereon is fed to the washing means 2.

The wire 7 after electrocoating is fed to the washing means 2, where the electrodeposition bath liquid adhering to the wire 7 is removed. The wire 7 after washing is fed to the heating means 3, where the wire 7 is heated and the electrodeposited coat (insulating coat) is thereby completed on the electrodeposited surface. The washing means comprises a washing bath 8. The heating oven 9 to be used in the above heating means 3 is not particularly restricted. When, for example, near-infrared rays and far-infrared rays are combinedly used, the electrodeposited coating film surface and the inside face can be heated uniformly, so that the surface tension is suppressed and an insulating coat rich in flexibility can be formed. For that purpose, the heating oven 9 is preferably provided with three zones, namely (1) a ordinary temperature drying oven (not indispensable), (2) a near-infrared zone (a near-infrared lamp being used), and (3) a far-infrared zone (a far-infrared heater being used). While the length of each zone can be selected in an appropriate manner, it is preferred, for attaining complete cure in the coat inside, that the far-infrared zone (3), in particular, be longer than-the other zones.

The above-mentioned pretreatment means 4 is not indispensable but is intended for removing the adhering lubricant and metal dust resulting from the process of production of the wire 7. The pretreatment means 4 is constituted of a degreasing bath 10 and a water washing bath 11. In the degreasing bath 10, the lubricant and metal dust adhering to the wire 7 are removed by a degreasing liquid sprayed from a sprayer and, in the water washing bath 11, the degreasing liquid is washed off with water. In the water washing bath 11, the wire is preferably washed with city water and then subjected to final washing with pure water.

The article to be coated to which the method of coating an electric wire of the invention can be applied is not particularly restricted but may be any of those electric wires which show electric conductivity for enabling the cationic electrocoating, for example electric wires made of iron, copper, aluminum, gold, silver,-nickel, tin, zinc, titanium, tungsten or the like, or an alloy containing such metals. Preferred are electric wires made of copper, gold, aluminum or iron or an alloy containing these as main constituents.

The shape of the article to be coated to which the method of coating an electric wire of the invention can be applied is not particularly restricted. The method can be adequately applied to an electric wire having at least one edge. The wire having at least one edge includes not only wires having no curvature in the edge but also wires having, in the edge, a curvature of not more than one fifth relative to the shortest side. As such wires, there may be mentioned, for example, a triangular wire, a square wire, a polygonal wire, and a modified cross section wire. When the conventional electrodeposition coating compositions are used for coating articles having at least one edge, the edge is covered with an insulating coat only to an insufficient extent, with the result that an insulated wire inferior in dielectric breakdown voltage are obtained. On the contrary, in particular, when coating an electric wire is carried out using the cationic electrodeposition coating composition comprising a sulfonium group- and propargyl group-containing resin composition in accordance with the present invention, a coat excellent in dielectric breakdown voltage can be uniformly formed not only on the flat(s) but also on the edge(s). Thus, even when an electric wire having at least one edge are coated, an insulated wire excellent in dielectric breakdown voltage can be obtained. Therefore, even when the article to be coated is a square wire, an insulated wire excellent in dielectric breakdown voltage can be obtained.

The insulated wire obtained by the method of coating an electric wire of the invention has an insulating coat uniformly formed on the wire surface and is excellent in dielectric breakdown voltage. Thus, it can be stably used in a broad range of applications. Such insulated wire, too, constitutes an aspect of the present invention.

The method of coating an electric wire according to the invention is the method of coating an electric wire comprising cationic electrocoating with a cationic electrodeposition coating composition, wherein the cationic electrodeposition coating composition contains a resin composition having a hydratable functional group reducible directly by an electron and results in forming passive coat. Therefore, even when the immersion time in the electrodeposition bath is short, an insulated wire with an insulating coat formed thereon can be obtained in an efficient manner. In particular, when the above resin composition is a sulfonium group- and propargyl group-containing one, it is possible to efficiently produce an insulated wire having an insulating coat excellent in dielectric breakdown voltage as formed thereon. Even when the article to be coated has one or more edges, for example when it is a square wire, a uniform insulating coat can be formed-on the whole wire surface. Therefore, the above-mentioned method of coating an electric wire can be adequately applied to electric wires having any arbitrary shape, and the insulated wire obtained are excellent in dielectric breakdown voltage and therefore can be used in a wide range of application fields.

The method of coating an electric wire according to the invention has the above-described constitution, so that an insulated wire excellent in dielectric breakdown voltage can be obtained by a relatively short time of immersion of the articles to be coated in the electrodeposition bath. It can adequately be applied also to an electric wire having an edge(s). Furthermore, the insulated wire obtained are excellent in dielectric breakdown voltage and therefore can be used in a wide range of application fields.

### EXAMPLES

The following examples illustrate the present invention more specifically. These examples are, however, by no means limitative of the scope of the invention. In the examples, “part(s)” means “parts by mass”, unless otherwise specified.

### Production Example 1

Production of a Sulfonium Group- and Propargyl Group-Containing Epoxy Resin Composition

Epototo YDCN-701 (100.0 parts) with an epoxy equivalent of 200.4 (cresol novolak-based epoxy resin, product of Toto Chemical), 23.6 parts of propargyl alcohol, and 0.3 part of dimethylbenzylamine were placed in a separable flask equipped with a stirrer, thermometer, nitrogen inlet tube and reflux condenser, the mixture was heated to 105° C., and the reaction was allowed to proceed at that temperature for 3 hours to give a propargyl group-containing resin composition with an epoxy equivalent of 1,580. To this was added 2.5 parts of acetylacetonato-copper, and the reaction was allowed to proceed at 50° C. for 1.5 hours. It was confirmed that part of the terminal hydrogens of the added propargyl groups was disappeared by proton (1H) NMR (propargyl converted to acetylide: 14 millioles/100 g of the resin solid matter). To this were added 10.6 parts of 1-(2-hydroxyethylthio)-2,3-propanediol, 4.7 parts of glacial acetic acid and 7.0 parts of deionized water, and the reaction was allowed to proceed for 6 hours while maintaining the temperature at 75° C. After confirmation that the residual acid value is less than 5, 43.8 parts of deionized water was added to give a desired resin composition solution. This solution had a solid matter content of 70.0% by mass, and the sulfonium value was 28.0 millimoles/100 g. The number average molecular weight (determined by GPC on the polystyrene equivalent basis) was 2,443.

### Production Example 2

Production of a Cationic Electrodeposition Coating Composition

The epoxy resin composition obtained in Production Example 1 (142.9 parts) and 157.1 parts of deionized water were stirred in a high-speed rotary mixer for 1 hour and, then, 373.3 parts of deionized water was further added to prepare an aqueous solution with a solid matter concentration of 15% by mass. A cationic electrodeposition coating composition was thus obtained.

### Production Example 3

Production of a Polyimide Anionic Electrodeposition Coating Composition

A reaction vessel equipped with a stirrer, thermometer, nitrogen inlet tube and reflux condenser with a water separation receptacle was charged with 64.44.parts of 3,4,3′,4′-benzophenonetetracarboxylic dianhydride, 43.26. parts of bis[4-(3-aminophenoxy)phenyl]sulfone, 3.00 parts of valerolactone, 400.00 parts of 1-methyl-2-pyrrolidone and 60.00 parts of toluene, and the mixture was stirred in a nitrogen atmosphere at 30° C. for 30 minutes. Then, the reaction vessel was heated and the reaction was allowed to proceed at 180° C. for 1 hour.

After reaction, 30 ml of a toluene-water distillate fraction was separated and removed and, then, the reaction was allowed to proceed at 180° C. for 2.5 hours while the subsequent distillate fractions were separated and removed out of the system in the same manner. Thus was obtained the desired polyimide resin with a solid content of 20% by mass.

The above polyimide resin (100.00 parts) was blended with 37.50 parts of 1-methyl-2-pyrrolidone, 112.50 parts of tetrahydrothiophene-1,1-dioxide, 75.00 parts of benzyl alcohol, 5.00 parts of methylmorpholine and 30.000 parts of pure water with stirring. Thus was prepared a polyimide anionic electrodeposition coating composition.

### Example 1

Insulated wires were obtained by subjecting a round copper wire (0.2 mm ø) having no edge to the following pretreatment means, electrodeposition means, washing means and heating means.

[Pretreatment Means]

(1) The electric wire was degreased with Surf Power (product of Nippon Paint Co.) at a treatment temperature of 45° C. for a treatment period of 60 seconds.

(2) The degreased wire was washed with water by spraying for 30 seconds.

[Electrodeposition Means]

The wire after water washing was immersed in the cationic electrodeposition coating composition obtained in Production Example 2 as contained, as the electrodeposition bath liquid, in the electrodeposition bath at a bath temperature of 30° C. and at an applied voltage of 100 V to thereby conduct cationic electrocoating (with the wire as the cathode and the counter electrode as the anode). The immersion period was varied as specified in Table 1,

[Washing Means]

The wire obtained after each immersion period of cationic electrocoating was washed with water by spraying for 30 seconds to remove the cationic electrodeposition coating composition adhering to the wire.

[Heating Means]

Each wire after washing was heated in a hot air heating oven at 190° C. for 25 minutes to give the corresponding insulated wire with an insulating coat formed thereon.

### Example 2

Insulated wires were obtained in the same manner as in Example 1 except that a square copper wire having edges (each side being 1 mm long, and the curvature R in the edge being 50 μm) was used as the article to be coated.

### Comparative Example 1

Insulated wires were obtained by subjecting a round copper wire (0.2 mm ø) having no edge to the following pretreatment means, electrodeposition means, washing means and heating means.

[Pretreatment Means]

The same pretreatment means as in Example 1 was used.

[Electrodeposition Means]

The wire after water washing was immersed in the polyimide anionic electrodeposition coating composition obtained in Production Example 3 as contained, as the electrodeposition bath liquid, in the electrodeposition bath at a bath temperature of 30° C. and at an applied voltage of 100 V to thereby conduct anionic electrocoating (with the wire as the anode and the counter electrode as the cathode). The immersion period was varied as specified in Table 1.

[Washing Means]

The same washing means as in Example 1 was used.

[Heating Means]

Each wire after washing was heated in a hot air heating oven at 120° C. for 30 minutes and then again at 200° C. for 30 minutes to give the corresponding insulated wire with an insulating coat formed thereon.

### Comparative Example 2

Insulated wires were obtained in the same manner as in Comparative Example 1 except that a square copper wire having edges (each side being 1 mm long, and the curvature R in the edge being 50 μm) was used as the article to be coated.

### Comparative Example 3

Insulated wires were obtained in the same manner as in Example 1 except that Power Top U-30 (blocked isocyanate curing type epoxy resin-based cationic electrodeposition coating composition, product of Nippon Paint Co.) was used in lieu of the cationic electrodeposition coating composition obtained in Production Example 2.

### Comparative Example 4

Insulated wires were obtained in the same manner as in Example 2 except that Powertop U-30 (blocked isocyanate curing type epoxy resin-based cationic electrodeposition coating composition, product of Nippon Paint) was used in lieu of the cationic electrodeposition coating composition obtained in Production Example 2.

[Evaluation]

The insulated wires obtained in Examples 1 and 2 and Comparative Examples 1 to 4 were evaluated from a dielectric breakdown voltage viewpoint using a model 8525 withstanding voltage insulation tester.(product of Tsuruga Electric Co.) by the metal foil method according to JIS C 3003. The results are shown in Table 1.

The line speed of the apparatus was measured in each run in the production of the insulated wires of Examples 1 and 2 and Comparative Examples 1 to 4. The results are shown in Table 1.

TABLE 1

| | Immersion time | Dielectric breakdown | Line speed |
|---|---|---|---|
| | (sec) | voltage (kV) | (m/min) |
| Example 1 | 1 | 5.8 | 40 |
| | 2 | 6.0 | 30 |
| | 5 | 6.2 | 20 |
| Example 2 | 1 | 5.3 | 40 |
| | 2 | 5.8 | 30 |
| | 5 | 6.0 | 20 |
| Comparative | 5 | 0*⁾ | 20 |
| Example 1 | 20 | 0.3 | 5 |
| | 40 | 0.6 | 2.5 |
| Comparative | 5 | 0^{*)} | 20 |
| Example 2 | 20 | 0.2 | 5 |
| | 40 | 0.3 | 2.5 |
| Comparative | 5 | 0*⁾ | 20 |
| Example 3 | 20 | 1.2 | 5 |
| | 40 | 2.0 | 2.5 |
| Comparative | 5 | 0*⁾ | 20 |
| Example 4 | 20 | 0.5 | 5 |
| | 40 | 0.8 | 2.5 |

*⁾The insulating coat was irregular in thickness and no precise measured values could be obtained.

As is evident from Table 1, when insulated wires are produced in the manner of Example 1 or 2, the coat deposition time is short as compared with the case of production according to Comparative Examples 1 to 4 and, therefore, the immersion time in the electrodeposition bath can be shortened and, as a result, the line speed of the apparatus can be increased. The insulated wires obtained in Examples 1 or 2 were superior in dielectric breakdown voltage characteristics to those obtained in Comparative Examples 1 to 4.

1. A method of coating an electric wire comprising cationic electrocoating with a cationic electrodeposition coating composition,
wherein the cationic electrodeposition coating composition contains a resin composition having a hydratable functional group reducible directly by an electron and results in forming passive coat.

2. The method of coating an electric wire according to claim 1,
wherein the resin composition is a sulfonium group- and propargyl group-containing one.

3. The method of coating an electric wire according to claim 1,
wherein the resin composition has a sulfonium group content of 5 to 400 millimoles, a propargyl group content of 10 to 495 millimoles, a propargyl group content of 10 to 495 millimoles and a total content of the sulfonium and propargyl groups of not more than 500 millimoles, per 100 g of the solid matter in said resin composition.

4. The method of coating an electric wire according to claim 1,
wherein the resin composition has a sulfonium group content of 5 to 250 millimoles, a propargyl group content of 20 to 395 millimoles and a total content of the sulfonium and propargyl groups of not more than 400 millimoles, per 100 g of the solid matter in said resin composition.

5. The method of coating an electric wire according to claim 1,
wherein the resin composition has an epoxy resin as a skeleton.

6. The method of coating an electric wire according to claim 1,
wherein the epoxy resin is a novolak cresol epoxy resin or a novolak phenol epoxy resin and has a number average molecular weight of 700 to 5000.

7. The method of coating an electric wire according to claim 1,
wherein the cationic electrocoating is carried out using a cationic electrocoating apparatus for an electric wire comprising an electrodeposition means, a washing means and a heating means as combined in that order.

8. The method of coating an electric wire according to claim 7,
wherein the electrodeposition means is one in which an article to be coated is immersed in an electrodeposition bath for 0.1 to 10 seconds.

9. The method of coating an electric wire according to claim 1,
wherein the article to be coated is an electric wire having at least one edge.

10. The method of coating an electric wire according to claim 1,
wherein the article to be coated is a square electric wire.

11. An insulated wire obtained by the method of coating an electric wire according to claim 1.

12. The method of coating an electric wire according to claim 2,
wherein the resin composition has a sulfonium group content of 5 to 400 millimoles, a propargyl group content of 10 to 495 millimoles, a propargyl group content of 10 to 495 millimoles and a total content of the sulfonium and propargyl groups of not more than 500 millimoles, per 100 g of the solid matter in said resin composition.

13. The method of coating an electric wire according to claim 2,
wherein the resin composition has a sulfonium group content of 5 to 250 millimoles, a propargyl group content of 20 to 395 millimoles and a total content of the sulfonium and propargyl groups of not more than 400 millimoles, per 100 g of the solid matter in said resin composition.

14. The method of coating an electric wire according to claim 3,
wherein the resin composition has a sulfonium group content of 5 to 250 millimoles, a propargyl group content of 20 to 395 millimoles and a total content of the sulfonium and propargyl groups of not more than 400 millimoles, per 100 g of the solid matter in said resin composition.

15. The method of coating an electric wire according to claim 2,
wherein the resin composition has an epoxy resin as a skeleton.

16. The method of coating an electric wire according to claim 3,
wherein the resin composition has an epoxy resin as a skeleton.

17. The method of coating an electric wire according to any of claim 4,
wherein the resin composition has an epoxy resin as a skeleton.

18. The method of coating an electric wire according to claim 2,
wherein the epoxy resin is a novolak cresol epoxy resin or a novolak phenol epoxy resin and has a number average molecular weight of 700 to 5000.

19. The method of coating an electric wire according to claim 3,
wherein the epoxy resin is a novolak cresol epoxy resin or a novolak phenol epoxy resin and has a number average molecular weight of 700 to 5000.

20. The method of coating an electric wire according to claim 4,
wherein the epoxy resin is a novolak cresol epoxy resin or a novolak phenol epoxy resin and has a number average molecular weight of 700 to 5000.
